(19) United States
(12) Patent Application Publication
(10) Pub. No.: US 2009/0311460 A1
(43) Pub. Date: Dec. 17, 2009

(54) SEMICONDUCTOR WAFER

(75) Inventors: Tomohiro HASHII, Tokyo (JP); Kazushige TAKAISHI, Tokyo (JP); Shinji SAKAMOTO, Nagasaki (JP); Tomoko OHMACHI, Nagasaki (JP)

Correspondence Address: GREENBLUM & BERNSTEIN, P.L.C., 1950 ROLAND CLARKE PLACE, RESTON, VA, 20191, US

(73) Assignees: SUMCO CORPORATION, Tokyo (JP); SUMCO TECHXIV CORPORATION, Nagasaki (JP)

(21) Appl. No.: 12/478,860

(22) Filed: Jun. 5, 2009

(30) Foreign Application Priority Data
Jun. 17, 2008 (JP) 2008-158387

(51) Int. Cl. B32B 3/02

(52) U.S. Cl. 428/64.1

(57) ABSTRACT

A semiconductor wafer with high flatness is provided. The semiconductor wafer has a diameter φ of 450 mm and a thickness of at least 900 μm and no greater than 1,100 μm.

This application is based on and claims the benefit of priority from Japanese Patent Application No. 2008-158387, filed on 17 June 2008, the content of which is incorporated herein by reference.

### BACKGROUND OF THE INVENTION

1. Field of the Invention

The present invention relates to a semiconductor wafer.

2. Related Art

Recently, size of a semiconductor wafer (hereinafter also referred to simply as “wafer”) used for manufacturing a semiconductor device is required to be larger, as size of chips increases in accordance with higher integration and functionality of semiconductor devices.

However, a large diameter wafer may cause various problems during manufacture. For example, Japanese Unexamined Patent Application Publication No. 2004-95942 (Patent Document 1) proposes technology for determining width of a groove on a wafer cassette for batch transportation by calculating an amount of deflection on the basis of diameter and thickness of a wafer to be loaded on the wafer cassette.

The disclosure in Patent Document 1 is regarding a wafer that has become thin after grinding of a back side thereof; however, in a case of a large diameter semiconductor wafer, an increased amount of deflection due to the wafer's own weight leads to a problem in loading and unloading of the wafer in a storage container and a problem of transportability of the wafer in a manufacturing device and the like. In addition, accompanying an increase in wafer diameter, it may be difficult to obtain high flatness in manufacturing.

### SUMMARY OF THE INVENTION

Given this, the present invention aims at providing a semiconductor wafer with high flatness.

In a first aspect of the present invention, a semiconductor wafer has a diameter of 450 mm and a thickness of at least 900 μm and no greater than 1100 μm.

According to a second aspect of the present invention, in the semiconductor wafer as described in the first aspect, an SFQR (Site Frontsite least sQuares focal plane site Range), which indicates local flatness of the semiconductor wafer, is preferably no greater than 25 nm.

According to a third aspect of the present invention, in the semiconductor wafer as described in the first and the second aspect, a GBIR (Global Backside Ideal focal plane Range), which indicates overall flatness of the semiconductor wafer, is preferably no greater than 0.1 μm.

According to the present invention, a semiconductor wafer with high flatness can be provided.

### BRIEF DESCRIPTION OF THE DRAWINGS

FIGS. 1A to 1C are diagrams illustrating an embodiment of a semiconductor wafer 1 according to the present invention;

FIG. 1A is a perspective view;

FIG. 1B is a diagram illustrating the semiconductor wafer 1 seen from a thickness direction;

FIG. 1C is a diagram illustrating the semiconductor wafer 1 seen in a radial direction; and

FIG. 2 is a flow chart showing manufacturing steps of the semiconductor wafer 1 according to the present embodiment.

### DETAILED DESCRIPTION OF THE INVENTION

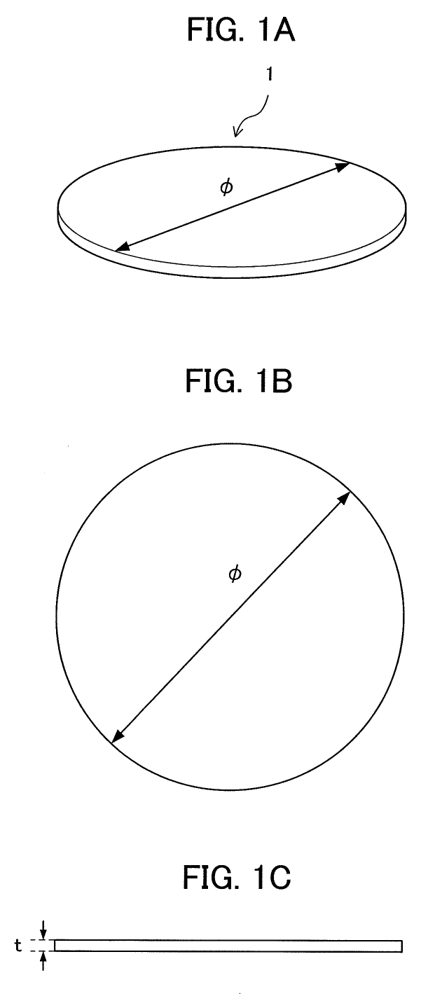

An embodiment of the semiconductor wafer according to the present invention is hereinafter described with reference to the drawings. FIGS. 1A to 1C are diagrams illustrating an embodiment of a semiconductor wafer 1 according to the present invention: FIG. 1A is a perspective view, FIG. 1B is a diagram illustrating the semiconductor wafer 1 seen from a thickness direction, and FIG. 1C is a diagram illustrating the semiconductor wafer 1 seen in a radial direction.

A semiconductor wafer 1 (hereinafter also referred to simply as “wafer”) according to the present embodiment has a diameter of 450 mm and a thickness of at least 900 μm and no greater than 1100 μm.

In addition, the wafer 1 according to the present embodiment is, for example, a silicon wafer or a gallium arsenide wafer.

As shown in FIGS. 1A and 1B, the wafer 1 according to the present embodiment has a diameter φ of 450 mm. Here, the diameter φ of the wafer 1 is a target value in manufacturing, and includes an allowable margin of error and the like in manufacturing. For example, the diameter φ of the wafer 1 includes an allowable margin of error of ±0.2 mm.

In the wafer 1 according to the present embodiment, a thickness t shown in FIG. 1C is at least 900 μm and no greater than 1100 μm. The significance thereof is that, in a case where the thickness t of the wafer 1 is smaller than 900 μm, deflection of the wafer becomes greater accompanying increasing diameter of the wafer, and treatment of the wafer becomes difficult. On the other hand, in a case where the thickness t of the wafer 1 exceeds 1100 μm, weight of the wafer becomes greater accompanying increasing diameter and increasing thickness of the wafer and thus handling of the wafer becomes difficult.

Here, as an index for evaluating flatness of the semiconductor wafer, for example, an SFQR (Site Frontsite least sQuares focal plane site Range) and a GBIR (Global Backside Ideal focal plane Range) can be used.

The SFQR is an index indicating local flatness of the wafer 1. More specifically, a plurality of rectangular samples of a predetermined size (for example, 26 mm×8 mm) is obtained from the wafer 1. And then the SFQR is obtained, for each of the samples thus obtained, by calculating a sum of absolute values of maximum amount of displacement from a reference plane obtained by a least-squares method.

The GBIR is an index indicating overall flatness of the wafer 1. More specifically, the GBIR is obtained by calculating difference between maximum displacement and minimum displacement of the overall wafer 1, with the back side of the wafer 1 as reference, under an assumption that the back side of the wafer 1 is completely vacuumed.

In the wafer 1 according to the present embodiment, the SQFR is preferably no greater than 25 nm, for thinning of devices formed on the wafer 1. In addition, the GBIR is preferably no greater than 0.1 μm, for thinning of devices formed on the wafer 1.

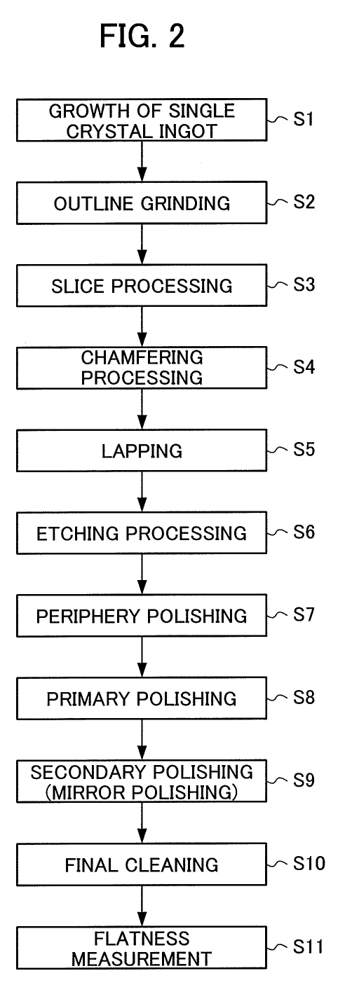

A manufacturing method for the wafer 1 according to the present embodiment is hereinafter described. FIG. 2 is a flow chart showing a manufacturing method for the semiconductor wafer 1 according to the present invention. As shown in FIG. 2, the manufacturing method for the semiconductor wafer 1 according to the present embodiment includes the following steps S1 to S11.

### (S1) Single Crystal Ingot Growth Step

First, a single crystal semiconductor ingot is grown by Czochralski method (CZ method), floating zone melting method (FZ method), or the like.

### (S2) Outline Grinding Step

The semiconductor ingot grown through the single crystal ingot growth step S1 has a front end portion and a rear end portion thereof cut off. In the outline grinding step, outline of the semiconductor ingot after being cut is ground by a cylindrical grinder or the like to trim the outline shape and give a block body having a uniform diameter.

### (S3) Slice Processing Step

An orientation flat or orientation notch is formed on the block body after the outline grinding step S2, to indicate a particular crystal orientation. After the processing, the block body is sliced with a wire saw or the like to give a wafer.

### (S4) Chamfering Step

A wafer obtained as a result of the slice processing step S3 is chamfered on a periphery thereof to prevent cracking and chipping on the periphery thereof. In other words, the peripheral portion of the wafer is chamfered into a predetermined shape by means of a chamfering grindstone. By the processing, the peripheral portion of the wafer is formed into a shape with a predetermined roundness.

### (S5) Lapping Step

After the chamfering step S4, a rough layer on each surface of the wafer that has a thin disk shape, generated by a process such as slicing, is made flat by lapping. In the lapping step, the wafer is disposed between lapping plates that are parallel to each other, and a lapping liquid, which is a mixture of alumina abrasive grains, a dispersing agent, and water, is poured in between the lapping plates and the wafer. Thereafter, the lapping plates and the wafer are rotated and ground together under pressure, thereby lapping both surfaces of the wafer. This can improve the flatness of both surfaces of the wafer and parallelism of the wafer.

### (S6) Etching Step

After the lapping step S5, the wafer is dipped in an etching solution and etched. In the etching step, the etching solution is supplied to a surface of the wafer while the wafer is spun by means of an etching device, for example. Then the etching solution being supplied spreads on the whole surface of the wafer by a centrifugal force of spinning, thereby etching the whole surface of the wafer and controlling surface roughness Ra of the surface of the wafer to a predetermined surface roughness. In this etching step, a work-affected layer introduced by the mechanical processes such as the chamfering step S4 and lapping step S5 is completely removed by etching.

### (S7) Periphery Polishing Step

After the etching step S6, a peripheral portion of the wafer is subjected to periphery polishing. The chamfered surface of the wafer is thus mirror-polished. In the periphery polishing step, the chamfered surface of the wafer is pressed against a peripheral surface of a polishing cloth circulating about an axis, while supplying polishing liquid, thereby mirror-polishing the chamfered surface.

### (S8) Primary Polishing Step

After the periphery polishing step S7, the wafer is subjected to primary polishing as coarse polishing of surfaces thereof, using a simultaneous double side polishing device that polishes both surfaces simultaneously.

### (S9) Secondary Polishing (Mirror Polishing) Step

After the primary polishing step S8, the wafer is subjected to secondary polishing as mirror polishing, using a simultaneous double side polishing device that polishes both surfaces simultaneously. It should be noted that, although both surfaces of the wafer are simultaneously polished by simultaneous double side polishing in the primary polishing step S8 and the secondary polishing step S9, the wafer can also be polished by single side polishing that polishes one surface thereof at a time.

### (S10) Final Cleaning Step

After the secondary polishing (mirror polishing) step S9, the wafer is subjected to final cleaning. More specifically, after the secondary polishing step S9, the wafer is cleaned with RCA cleaning solution.

### (S11) Flatness Measurement

After the final cleaning step S10, flatness of the wafer is measured as a finish level of polishing.

The wafer 1 having a diameter φ of 450 mm, a thickness t of at least 900 μm and no greater than 1100 μm, a SFQR of no greater than 25 nm, and a GBIR of no greater than 0.1 μm can be obtained by the manufacturing steps as described in the abovementioned steps S1 to S11.

Here, with regard to flatness required in manufacturing of a semiconductor wafer of 300 mm in diameter, the SQFR is 0.2 μm to 1.2 μm and the GBIR is 0.5 μm to 1.5 μm.

On the other hand, the wafer 1 of the present embodiment is thick enough not to be easily affected by the deflection of the wafer due to a large diameter thereof. As a result, with regard to the flatness of the wafer 1, the SQFR is no greater than 25 nm (0.25 μm) and the GBIR is no greater than 0.1 μm.

As described above, the wafer 1 of the present embodiment is thick enough not to be easily affected by the deflection of the wafer due to the large diameter and has a higher flatness than a semiconductor wafer of 300 mm in diameter. Therefore, according to the wafer 1 of the present embodiment, a wafer of a higher quality can be provided.

1. A semiconductor wafer having a diameter of 450 mm and a thickness of at least 900 μm and no greater than 1100 μm.

2. The semiconductor wafer according to claim 1, wherein an SFQR (Site Frontsite least sQuares focal plane site Range), which indicates local flatness of the semiconductor wafer, is no greater than 25 nm.

3. The semiconductor wafer according to claim 1, wherein a GBIR (Global Backside Ideal focal plane Range), which indicates overall flatness of the semiconductor wafer, is no greater than 0.1 μm.

4. The semiconductor wafer according to claim 2, wherein a GBIR (Global Backside Ideal focal plane Range), which indicates overall flatness of the semiconductor wafer, is no greater than 0.1 μm.
